(19) United States
(12) Patent Application Publication
(10) Pub. No.: US 2021/0308969 A1
(43) Pub. Date: Oct. 7, 2021

(54) COMPOSITE MATERIAL FABRICATION SYSTEM AND METHOD

(71) Applicant: Dov STEINBERG, Pardesia (IL)

(72) Inventor: Dov STEINBERG, Pardesia (IL)

(21) Appl. No.: 16/840,462

(22) Filed: Apr. 6, 2020

(51) Int. Cl. B29C 70/54; B29C 70/40

(52) U.S. Cl. CPC B29C 70/541; B29C 70/40; B29C 70/545

(57) ABSTRACT

A composite fabrication system for fabricating a cured composite structure from a first composite layup comprising a matrix of resin and fiber reinforcement, the matrix configured upon a first supporting membrane, the matrix having a percentage of voids value (PCT-V) and a volumetric resin-to-fiber reinforcement ratio value (R:F), the system comprising: a fluid control delivery system; a layup structure having a layup support surface; the first composite layup positioned on the layup support surface; a second composite layup formed of the first composite layup with a second supporting membrane spread upon the matrix, the matrix positioned between the first and second supporting membranes; a roller; a form; and a removable seal configured to seal the form over the second composite layup; wherein the pressurized fluid introduced by the fluid control delivery system serving to expand and bias the second composite layup intimately against the form.

### FIELD OF THE INVENTION and BACKGROUND

Embodiments of the current invention relate to the field composite materials and specifically to a composite material fabrication system and method.

Composite materials are usually both strong and lightweight, which, among many other variables, can save money and manpower, as compared with other materials. Fiber-reinforced composites—a general term covering a wide array of composite materials—offer excellent strength-to-weight ratios, frequently far exceeding those of other materials. For example, carbon fiber-reinforced composites are 70 percent lighter than steel and 40 percent lighter than aluminum. Producing parts and structures that are lightweight is critical to industries such as, but not limited to: transportation; infrastructure; consumer products; and aerospace.

Some composite material fabrication methods are derived from other material fabrication methods (for example, injection molding from the plastic industry) and other composite material fabrication methods have been developed to meet specific design or manufacturing challenges faced with fiber-reinforced polymers (referred hereinbelow as “FRP”). as known in the art. Selection of a method for a particular part and structure depends on the materials, the part design and end-use or application. Composite fabrication processes typically involve some form of molding to shape the resin and reinforcement. A mold tool is required to give the unformed resin/fiber combination its shape before and during cure—as known in the art. The methods discussed hereinbelow are typically applicable to a wide variety of structures, including, but not limited to: boat hulls, baths, swimming pools, storage tanks, and containers.

The most basic fabrication method for FRP composites is hand layup, which includes skilled manual processes including the so-called “wet layup”, “wet spray up”, and “prepreg” methods, inter alia, as known in the art. “Prepreg” materials usually involved additional material and handling cost and hand, wet layup, as described below and known in the art, is cheaper. Hand layup typically consists of manually placing layers, called “plies” (singular “ply”) of dry fabrics/fibers, onto the mold tool to form a laminate stack. In many cases, to correctly “fill” the tool, additional smaller pieces of fabric are necessary. Resin is applied to the dry plies after layup is complete (e.g., by means of resin infusion, by brush or other methods, as known in the art).

In the specification and claims which follow, the terms “tool”, “form”, and “mold” are used interchangeably and are intended to mean the same as “mold tool” as described hereinabove.

In a wet layup method, each ply is coated with resin and debulked (compacted) after it is placed in the tool. Although debulk can be done by hand with rollers, many fabricators use a vacuum-bagging technique which includes placing plastic sheet materials over the tool layup, sealing the tool at its edges, adding one or more ports for air hoses and then evacuating air from the space between the sheet and the layup using a vacuum pump. Debulking using a vacuum technique is directed to obtaining two results: (1) consolidating the layup to reduce the quantity of resin in the layup (usually measured volumetrically); and (2) removal/reduction of voids/air bubbles trapped in the layup resin matrix. Air bubbles trapped in the layup matrix create undesirable voids (also known as “air pockets”) that typically weaken the resultant composite structure.

Several curing methods for the layup are known in the art. The most basic method is to simply allow cure (initiated by a catalyst or hardener additive premixed into the resin) to occur at a given temperature, usually near room temperature, Cure can be accelerated by applying heat, typically with an oven, and by applying pressure, usually by means of a vacuum. For the latter, a vacuum bag, with breather assemblies is typically placed over the layup and attached to the mold tool (in similar fashion to that used in debulking), then a vacuum is pulled prior to initiation of cure. The vacuum bagging process further consolidates the plies of material and significantly reduces voids due to the off gassing that occurs as the matrix progresses through its chemical curing stages.

Additionally, some techniques employ sophisticated pressure and temperature control of the curing process. For example, some high-performance thermoset parts require heat and high consolidation pressure to cure—conditions that require the use of an autoclave. Autoclaves, generally, are expensive to buy and operate. Manufacturers equipped with autoclaves usually cure a number of parts simultaneously. Computer systems can be used to monitor and control autoclave temperature, pressure, vacuum and inert atmosphere to allow unattended and/or remote supervision of the cure process and to achieve optimized results of the technique.

The following publications are representative of the composite fabrication prior art and methods described hereinabove.

In U.S. Pat. No. 9,597,820, whose disclosure is incorporated by reference, Schnabel describes a method for producing a natural fiber-reinforced plastic part, wherein as the starting material natural fibers 5-120 mm in length, a thermoplastic and/or a duroplastic and a lubricant, especially wax, are pelletized without extrusion into long-fiber pellets by cold-forming and the long-fiber pellets are then feed for direct processing into a standard injection molding machine for injecting the plastic part.

Saigo et al., in U.S. Pat. No. 6,214,277, whose disclosure is incorporated by reference, describe plastic composite gears and bearings with excellent friction and wear properties and further, plastic composite molded parts with excellent dimensional accuracy, can be presented at a low cost without adding large quantities of solid lubricant and glass fibers, etc., by adding a crystalline nucleus to crystalline polymers, such as polyacetal, polyamide, polyphenylene sulfide, etc., molding while applying vibrational energy, heat-treating the molded part after molding at a temperature that is the glass transition point of the crystalline polymer or higher and the melting point of the crystalline polymer or lower, heat treating the molded part after molding in the presence of a natural mineral, or by irradiating the molded part after molding with far infrared rays or infrared rays in order to reduce spherulite size of the crystalline polymer in the molded part and increase the degree of polymerization and thereby control crystal morphology and reduce the coefficient of friction and specific wear rate, and the molded parts have excellent recyclability.

An article entitled: “Voids in fiber-reinforced polymer composites: A review on their formation, characteristics, and effects on mechanical performance”—by Mahoor Mehdikhani, Larissa Gorbatikh, Ignaas Verpoest, Stepan V Lomov, Journal of Composite Materials, Vol 53, pages 1579-1669, Issue 12, 2019, Sage Journals, SAGE Publications, 2455 Teller Road, Thousand Oaks, Calif. 91320 USA, whose disclosure is incorporated by reference, covers an array of composite considerations and characteristics, and notes, inter alia that: cure parameters, i.e. pressure, temperature and vacuum (pressure) are frequently optimized together, rather than separately, and; a1-3% increase in void content of a carbon fiber reinforced composite can reduce the mechanical properties by up to 20%.

It is generally understood, as noted above, that fabricated composite parts and structures exhibit higher strength and lower weight, among other desirable characteristics, with reduction of a percentage of voids/bubbles, noted hereinbelow in the specification and in the claims as “PCT-V”, and lowering the volume ratio of resin-to-fiber, noted hereinbelow in the specification and in the claims as “R:F”. Additionally, fabrication of composite parts and structures is frequently performed by skilled workers using different platforms and/or with differing work setups—which contribute to additional complexity, time, and cost in fabrication.

There is therefore a need for a layup composite system and methods that are simpler, saving material and cost, and allow fabrication of composite structures upon a unified platform and work setup by less-skilled workers, the fabricated structures having the same or superior weight and strength characteristics of other prior art composite systems and methods, while allowing fabrication to be done substantially on the same system.

### SUMMARY OF INVENTION

According to the teachings of the current invention, there is provided a composite fabrication system for fabricating a cured composite structure from a first composite layup comprising a matrix of resin and fiber reinforcement, the matrix configured upon a first supporting membrane, the matrix having a percentage of voids value (PCT-V) and a volumetric resin-to-fiber reinforcement ratio value (R:F), the system comprising: a fluid control delivery system having a pressurized fluid at a pressure exceeding one atmosphere; a layup structure having a layup support surface, the layup structure having a fluid inlet passage penetrating the layup support surface and connected to the fluid control delivery system; the first composite layup positioned on the layup support surface with the first supporting membrane contacting the layup support surface and a vibrational element mechanically attached to the layup structure, with operation of the vibrational element serving to lower PCT-V; a second composite layup formed of the first composite layup with a second supporting membrane spread upon the matrix, the matrix positioned between the first and second supporting membranes; a roller configured to displace excess resin in the matrix and lower R;F; a form having an internal, volumetric shape corresponding to a shape of the final composite structure, the form positioned over the second composite layup and the layup support surface, but substantially not contacting the second composite layup; and a removable seal configured to seal the form over the second composite layup; wherein the second composite layup is initially in contact with the form only at the removable seal, the pressurized fluid introduced by the fluid control delivery system serving to expand and bias the second composite layup intimately against the form.

Preferably, the layup surface is substantially flat and horizontal and has at least one sealing element configured thereupon, located substantially at a periphery of the layup support surface. Typically, the supporting membranes have an extended sheet shape and are formed from at least one material chosen from the list including: silicone rubber and vulcanized rubber. Most typically, the second composite layup extends over the entire layup support surface and over the at least one sealing element. Preferably, the removable seal is configured to seal the second composite layup against the at least one sealing element. Most preferably, the pressurized fluid introduced by the fluid control delivery system is vented when the second composite layup is substantially completely cured. Typically, the pressurized fluid is at least one chosen from the list including: a gas; water, and oil.

According to the teachings of the current invention, there is further provided a method of fabricating a cured composite structure using the composite fabrication system, the method comprising the following steps: laying up the first composite layup by: spreading the first supporting membrane upon the layup support surface; spreading the fiber reinforcement over the first supporting membrane; and applying resin to the fiber reinforcement; activating the vibrational element to outgas voids and to reduce PCT-V; spreading the second supporting membrane upon the matrix to form the second composite layup; applying uniform pressure to the second composite layup using a roller to displace excess resin and lower R:F; placing a form over the second composite layup; sealing the form onto the second composite layup with a removable seal, the second layup substantially not in contact with the form; opening a main inlet fluid valve of the fluid control delivery system to introduce the pressurized fluid in the fluid inlet passage and beneath the second composite layup to expand the second composite layup and to bias it intimately against the form; closing the main inlet fluid after the second composite layup has substantially cured, thereby yielding a cured composite structure, and then opening a fluid venting valve of the fluid control delivery system to vent the fluid; removing the removable seal and the form from the cured composite structure once curing is completed, after any necessary cooling to ambient/near ambient conditions; and removing the supporting membranes from the cured composite structure.

According to the teachings of the current invention, there is provided a composite fabrication system for fabricating a cured composite structure from a composite layup comprising a matrix of resin and fiber reinforcement, the matrix configured between a first and a second supporting membrane, the matrix having a percentage of voids value (PCT-V) and a volumetric resin-to-fiber reinforcement ratio value (R:F), the system comprising: a fluid control delivery system having a pressurized fluid at a pressure exceeding one atmosphere; a layup structure having a first layup support surface, the layup structure having a fluid inlet passage penetrating the first layup support surface and connected to the fluid control delivery system; the composite layup positioned on a second layup support surface with the first supporting membrane contacting the layup support; a roller configured to displace excess resin in the matrix and lower R;F and PCT-V; a form having an internal, volumetric shape corresponding to a shape of the final composite structure, the form positioned over the composite layup and the layup support surface, but substantially not contacting the second composite layup; and a removable seal configured to seal the form over the composite layup and against the second layup support surface; wherein the composite layup is initially in contact with the form only at the removable seal, the pressurized fluid introduced by the fluid control delivery system serving to expand and bias the composite layup intimately against the form.

Preferably, the second layup support surface has an elongated cylindrical shape having a first and a second end, respectively, the second end closed, having a substantial semispherical closure, and the first end open, having a substantially right-angle truncation. Most preferably, the second layup support surface is positioned substantially vertically, with the first end opening onto the first layup support surface, centered substantially above inlet passage, and sealed at the first end onto the first layup support surface. Typically, the supporting membranes have an extended sheet shape and are formed from at least one material chosen from the list including: silicone rubber and vulcanized rubber. Most typically, the composite layup extends over the entire second layup support surface, towards the first layup support surface.

Preferably, the removable seal is positioned at an end of the form, towards the first end, the removeable seal configured to seal the composite layup between the form and the second layup surface. Most preferably, the pressurized fluid introduced by the fluid control delivery system is vented when the composite layup is substantially completely cured. Typically, the pressurized fluid is at least one chosen from the list including: a gas; water, and oil.

According to the teachings of the current invention, there is further provided a method of fabricating a cured composite structure using the composite fabrication system, the method comprising the following steps: laying up the composite layup by: spreading the first supporting membrane upon the layup support surface; spreading the fiber reinforcement over the first supporting membrane; and applying resin to the fiber reinforcement; spreading the second supporting membrane upon the matrix; applying uniform pressure to the composite layup using a roller to displace excess resin and lower R:F and to reduce PCT-V; placing a form over the second composite layup; sealing the form onto the second composite layup with a removable seal, the composite layup substantially not in contact with the form; opening a main inlet fluid valve of the fluid control delivery system to introduce the pressurized fluid in the fluid inlet passage and inside the composite layup to expand the composite layup and to bias it intimately against the form; closing the main inlet fluid after the composite layup has substantially cured, thereby yielding a cured composite structure, and then opening a fluid venting valve of the fluid control delivery system to vent the fluid; removing the removable seal and the form from the cured composite structure once curing is completed, after any necessary cooling to ambient/near ambient conditions; and removing the supporting membranes from the cured composite structure.

### LIST OF FIGURES

The invention is described herein, by way of example only, with reference to the accompanying drawings, wherein:

FIGS. 1A and 1B are a schematic side view of a composite fabrication system, with a first composite layup disposed substantially horizontally, and a detailed cross-sectional side view the first composite layup, respectively, in accordance with embodiments of the current invention.

FIGS. 2A and 2B, which are a schematic side view of the composite fabrication system of FIG. 1A, with a second composite layup disposed substantially horizontally, and a detailed cross sectional side view of the second composite layup, respectively, in accordance with embodiments of the current invention

FIGS. 3 to 6 are schematic side views of the composite fabrication system, in accordance with embodiments of the current invention; and

FIGS. 7 to 11 are schematic side views of a composite fabrication system, with a composite layup disposed substantially vertically about a tubular support, representing a layup support surface, the composite layup and layup support surface shown schematically in cross sectional side view, in accordance with embodiments of the current invention.

### DETAILED DESCRIPTION

Embodiments of the current invention relate to the field composite materials and specifically to a composite material fabrication system and method.

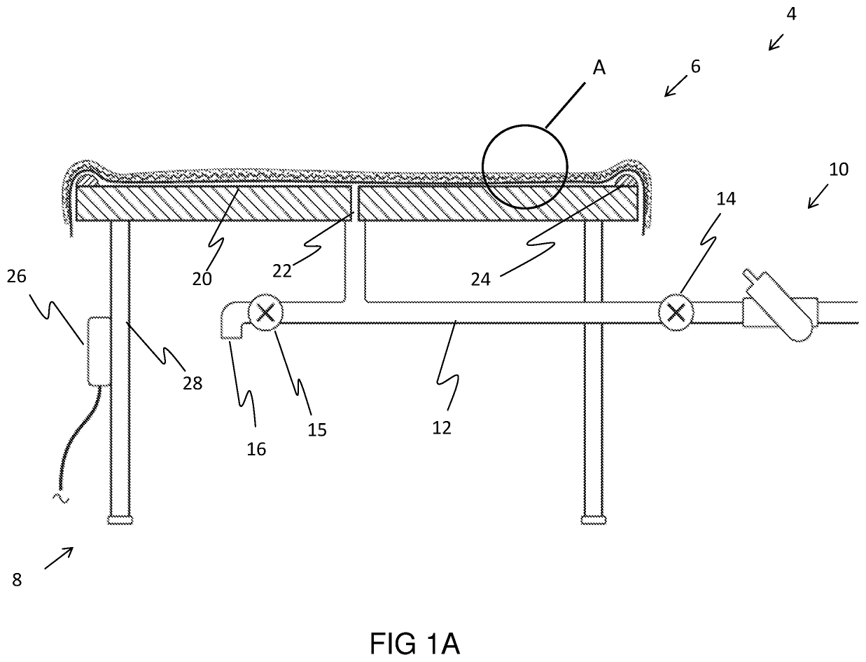

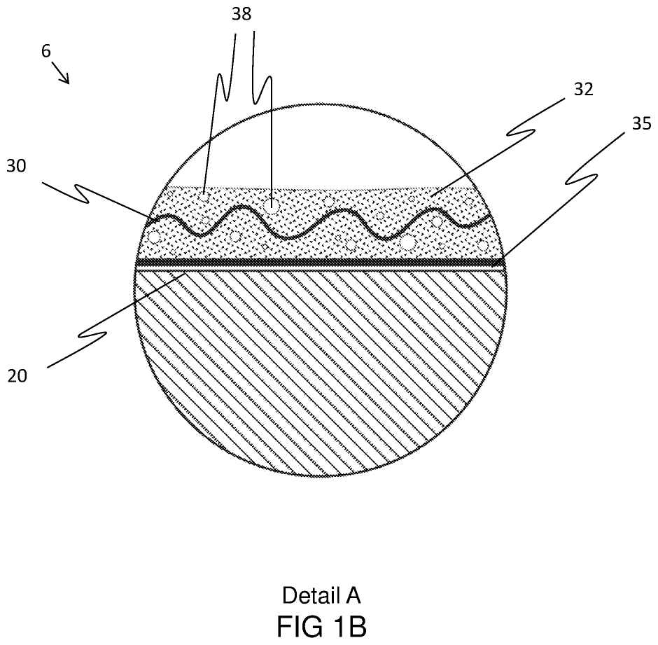

Reference is currently made to FIGS. 1A and 1B, which are a schematic side view of a composite fabrication system 4, with a first composite layup 6 disposed substantially horizontally, and a detailed cross sectional side view of first composite layup 6, respectively, in accordance with embodiments of the current invention. Composite fabrication system 4 includes a layup structure 8 and a fluid control delivery system 10. Fluid control delivery system 10 includes: a main inlet fluid valve 14; a fluid delivery piping configuration 12; a fluid venting valve 15; and a fluid vent outlet 16. Fluid control delivery system 10 serves to deliver a fluid (not indicated in the current figure). Main inlet fluid valve 14 and fluid venting valve 15 are initially in a closed position.

Layup structure 8 includes: a substantially flat and horizontal layup support surface 20, a fluid inlet passage 22 shown leading from the fluid delivery piping configuration and penetrating layup support surface 20; at least one sealing element 24 configured on the layup support surface, substantially at a periphery of the layup support surface; and a vibrational element 26 mechanically connected to a support 28 of the layup support surface, the vibrational element shown schematically connected to an electrical power source. Support 28 may be a set of four legs, typical for a table support, or any other similar structure allowing the layup support surface to be stably positioned for placing first composite layup 6 and additional elements thereupon, as further described hereinbelow.

The first composite layup and elements of layup structure 8, namely: the layup support surface, the fluid inlet passage; and the at least one sealing element are all shown schematically in cross-section. Furthermore, layup support surface 20 and the at least one sealing element 24 has a geometric shape such as, but not limited to: rectangular, circular, square, triangular, and hexagonal, with the at least one sealing element 24 being configured mutatis mutandis to allow for a seal, as further described hereinbelow, corresponding to the shape of first composite layup 6, which typically extends over the entire layup support surface and beyond, as indicated in FIG. 1A.

FIG. 1B shows a detailed sectional view of first composite layup 6, which includes: fiber reinforcement 30 (shown schematically as a wavy line); a resin 32; a first supporting membrane 35; and voids 38. Examples of materials constituting fiber reinforcement 30 are, but not limited to: fiberglass, polymers, and carbon fibers, with fiber reinforcement 30 typically having an extended sheet shape. Examples of materials constituting first supporting membrane 35 are, but not limited to: silicone rubber and vulcanized rubber—also having an extended sheet shape. The term “matrix” used herein and in the claims which follow is intended to mean the combined mixture/structure of fiber reinforcement 30 and resin 32, with associated voids 38.

A first step in a first method to form a composite material using composite fabrication system 4 includes forming (or “laying up”) first composite layup 6 by spreading first supporting membrane 35 upon layup support surface 20, with the first supporting membrane closely complying with the layup support surface; followed by spreading fiber reinforcement 30 over the first supporting membrane. Embodiments of the current invention typically avoid and/or minimize cutting additional pieces of fiber reinforcement, but instead use complete and/or larger sheets of fiber, thereby generally saving time and fiber reinforcement material as part of the layup process. The term “matrix” used hereinbelow in the specification and in the claims which follow is intended to mean the combined mixture/structure of fiber reinforcement 30 and resin 32, with voids 38.

Resin 32 is then applied to fiber reinforcement 30 by means of resin infusion, such as, but not limited to: brush or other methods, as known in the art. A typical result following resin application, as shown in the figure, is a layer of the fiber reinforcement impregnated with the resin typically having voids 38, otherwise referred to as “bubbles”, as known in the art. As noted hereinabove, PCT-V represents the relative percentage of voids 38 in the matrix, whether measured volumetrically or by mass.

Following application of resin, vibrational element 26 is activated to effectively outgas some of voids 38 by introducing vibrations into layup support surface 20 having first composite layup 6 spread thereupon. Operating the vibrational element for a specified time (typically from at least 10 seconds to a few minutes) and with a range of vibrational frequencies of 10 to 500 Hz, with amplitudes of under a few millimeters serves to significantly reduce PCT-V.

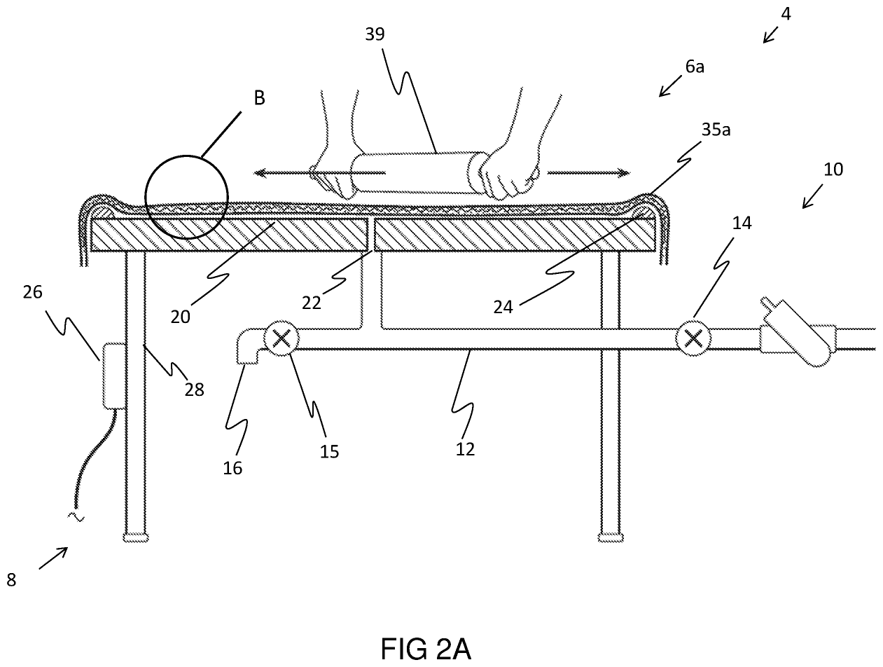

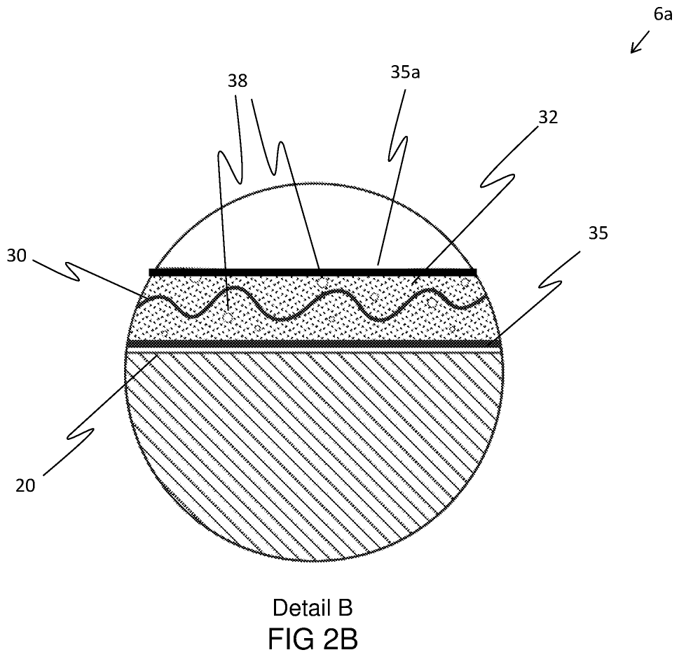

Reference is currently made to FIGS. 2A and 2B, which are a schematic side view of composite fabrication system 4 of FIG. 1A, with a second composite layup 6a disposed substantially horizontally, and a detailed cross sectional side view of second composite layup 6a, respectively, in accordance with embodiments of the current invention.

Apart from differences described below, composite fabrication system 4, layup structure 8, and fluid delivery system 10 of FIG. 2A are identical in notation, configuration, and functionality to that shown in FIG. 1A (and of subsequent figures), and elements indicated by the same reference numerals and/or letters are generally identical in configuration, operation, and functionality as described hereinabove. In both of the referenced figures.

FIG. 2B shows a detailed sectional view of second composite layup 6a, which includes all of the elements of first composite layup 6 shown in FIG. 1B, and following PCT-V reduction (i.e. reduction of the voids in the resin) as described hereinabove—and as shown schematically in the figure—second supporting membrane 35a is spread upon the matrix of fiber reinforcement 30 impregnated with the resin, the second supporting membrane substantially having the same dimensions of the first supporting membrane.

With second supporting membrane 35a spread upon the matrix as show in FIG. 2B, uniform pressure is applied to second composite layup 6a as shown schematically by a roller 39 and arrows in FIG. 2A to displace excess resin 30 in the second composite layup from between the two supporting membranes by applying uniform pressure on the second composite layup. Manual rolling—or any combination of rolling with electro-mechanical means with roller 39 yields good results in displacing excess resin and thereby effectively lowering the volume ratio of resin-to-fiber, noted hereinabove as R:F.

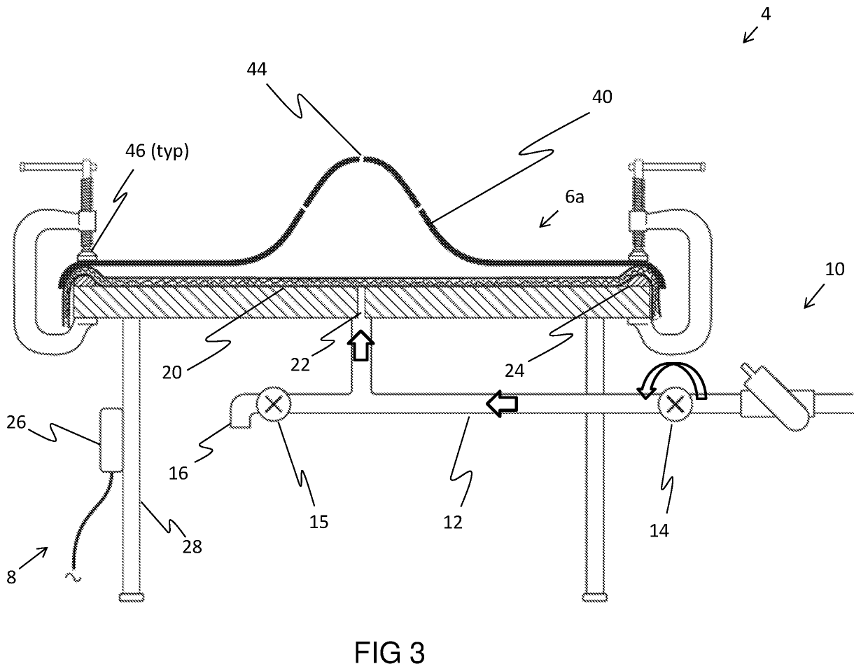

Reference is currently made to FIGS. 3 to 6, which are schematic side views of composite fabrication system 4, in accordance with embodiments of the current invention. Apart from differences described below, composite fabrication system 4, layup structure 8, and fluid delivery system 10 of FIGS. 3 to 6 are identical in notation, configuration, and functionality to that shown in FIGS. 1 A and 2A, and elements indicated by the same reference numerals and/or letters are generally identical in configuration, operation, and functionality as described hereinabove.

FIGS. 3 to 6 are intended to show subsequent steps in a first method to form a composite material using composite fabrication system 4, as described hereinbelow. In FIG. 3 a form 40 is placed over second composite layup 6a—but substantially not contacting the form, as described below. The form is schematically shown in cross section and extending over second composite layup 6 and the entire layup support surface and beyond, as indicated the figure. Form 40 has an internal, volumetric shape corresponding to a shape of the final composite structure to be fabricated, as known in the art. Exemplary shapes of the final structure may include, but are not limited to: a bowl, a hull of a water vessel, and a supporting structure. Form 40 has at least one vent opening 44, the vent opening described further hereinbelow.

The next step in a first method is to seal the form onto second layup 6a and at least one seal 24 using a removable seal 46, schematically shown as “C” clamps. Removable seal 46 make take the form of any mechanism and configuration thereof effecting a seal as described hereinabove. Except for contacting the form at the removable seal, second composite layup 6a is substantially not in contact with the form in the current step.

The next step in the first method is to open main inlet fluid valve 14 to introduce a pressurized fluid (the fluid and its direction of flow indicated by arrows in the figure) into fluid inlet passage 22. Examples of the pressurized fluid include, but are not limited to: air, any other gas, water, and oil. Pressure values of the pressurized fluid exceed one atmosphere and the values range to a number of multiples of atmospheric pressure. Typically, the pressurized fluid is heated above ambient temperature, the temperature and pressure of the fluid determined by resin curing qualities, as known in the art. Generally, higher fluid pressure and temperature yield faster curing times whereas lower fluid pressure and temperature yield slower curing times.

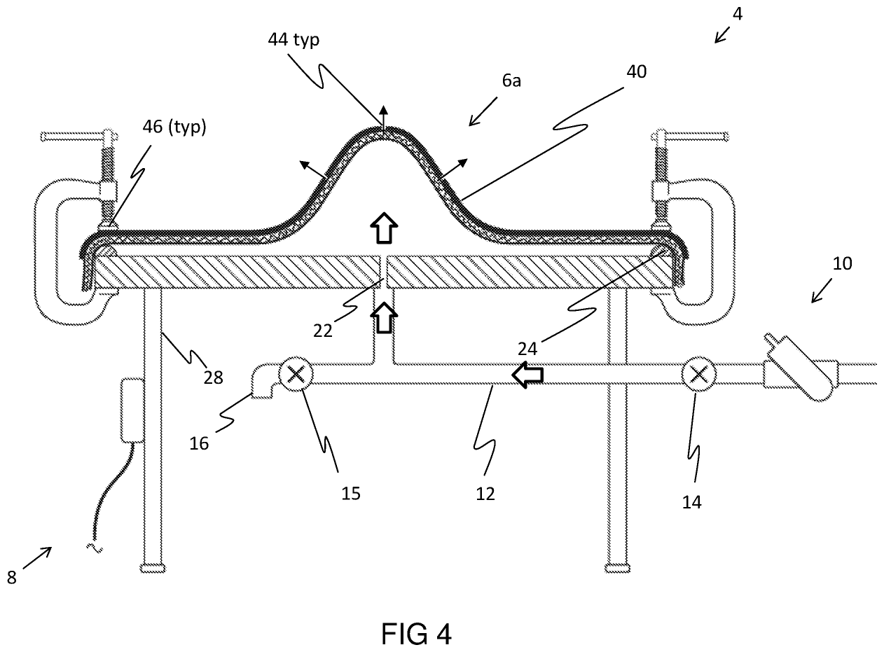

Introduction of the pressurized fluid into fluid inlet passage 22 and beneath second composite layup 6a serves to expand the second composite layup and to bias it intimately against form 40, as shown schematically in FIG. 4. Whereas prior art systems may incorporate vacuum systems to exert force upon a composite layer, it is clear that when the pressurized fluid pressure value exceeds one atmosphere, the resultant force is larger than a vacuum system, which is limited to a pressure difference of up to one atmosphere.

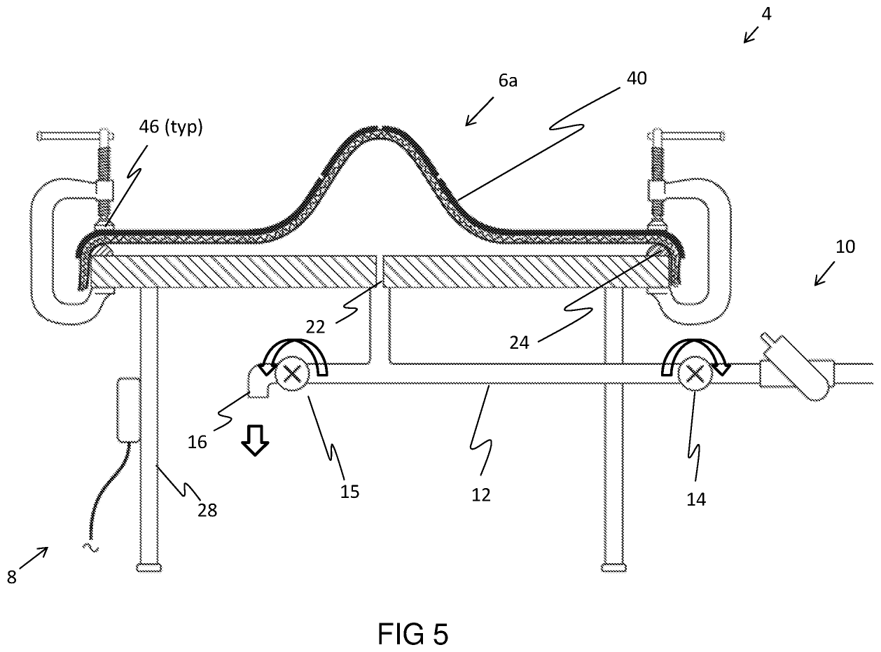

The at least one vent opening 44 serves to allow any ambient air to escape the form (as shown schematically by the smaller arrows) as the second composite layup is inflated and biased against form 40. In FIG. 4, main inlet fluid valve 14 remains in an open position as the pressurized fluid is maintained, as shown in the figure. After a prescribed time (typically ranging a number of minutes, according to the curing characteristics of the resin) when the second composite layup has substantially completely cured, main inlet fluid valve 14 is closed, and then fluid venting valve 15 is opened to allow venting of the fluid to fluid vent outlet 16—all as shown schematically in FIG. 5.

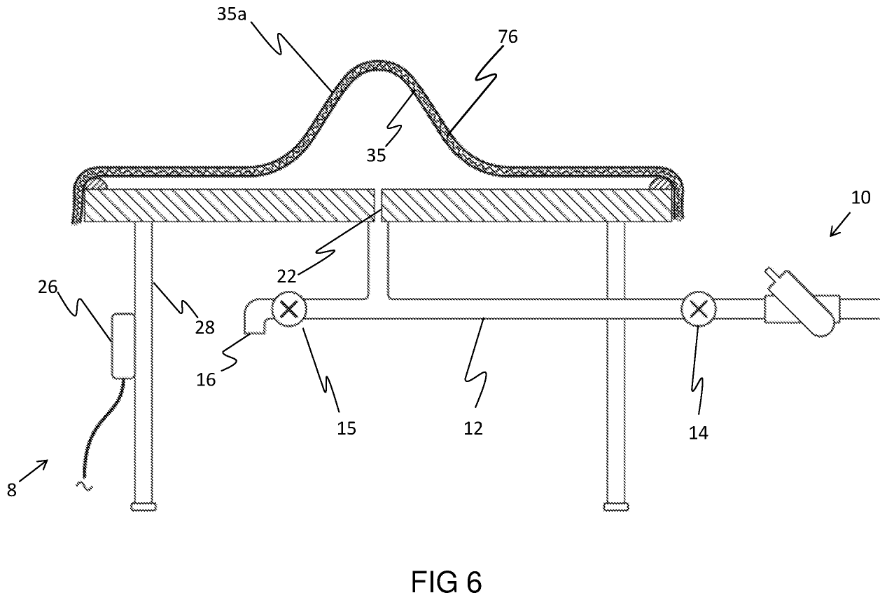

Once curing is completed, including any necessary cooling to ambient/near ambient conditions, removable seal 46 and form 40 are removed, and a cured composite structure 76, enclosed in first supporting membrane 35 and second supporting membrane 35a remains, as shown in FIG. 6. The supporting membranes are then removed from the cured composite structure and the structure is further shaped (i.e. machining, cutting, etc.) as known in the art. Because the smooth supporting membranes enclosed the matrix before and during curing, the cured composite structure exhibits a similar smooth surface finish.

The first method of to form a composite material using composite fabrication system 4 is summarized by the following steps:
a. Laying up the first composite layup by:
   a. spreading the first supporting membrane upon the layup support surface;
   b. spreading the fiber reinforcement over the first supporting membrane; and
   c. applying resin to the fiber reinforcement.
b. Activating the vibrational element to outgas some of the voids and reduce PCT-V.
c. Spreading the second supporting membrane upon the matrix to form the second composite layup.
d. Applying uniform pressure to the second composite layup using a roller to displace excess resin and lower R:F.
e. Placing a form over the second composite layup.
f. Sealing the form onto the second composite layup with a removable seal, the second layup substantially not in contact with the form.
g. Opening the main inlet fluid valve to introduce the pressurized fluid in the fluid inlet passage and beneath the second composite layup to expand the second composite layup and to bias it intimately against the form.
h. Closing the main inlet fluid after the second composite layup has substantially cured, and thereby yielding a cured composite structure, and then opening the fluid venting valve to vent the fluid.
i. Removing the removable seal and the form from the cured composite structure once curing is completed, after any necessary cooling to ambient/near ambient conditions.
j. Removing the supporting membranes from the cured composite structure.

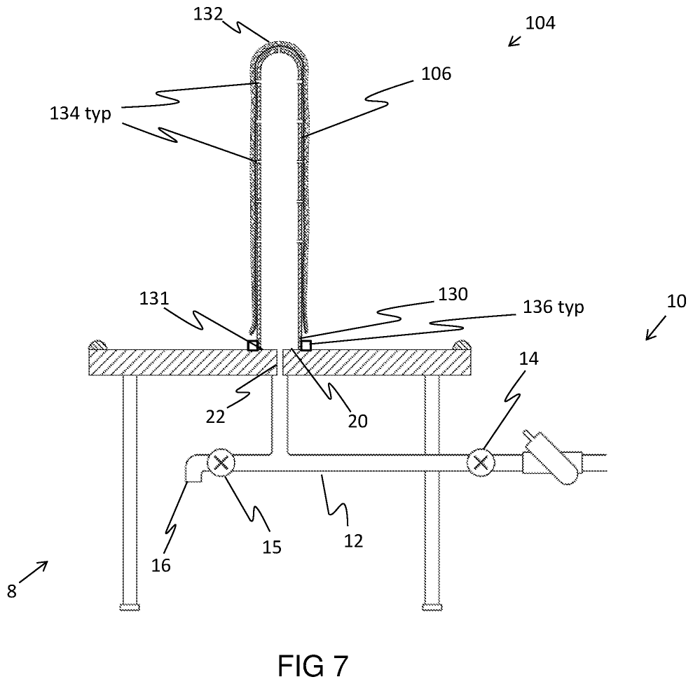

Reference is currently made to FIGS. 7 to 11, which are schematic side views of a composite fabrication system 104, with a composite layup 106 disposed substantially vertically about a tubular support, representing a layup support surface130, the composite layup and layup support surface shown schematically in cross sectional side view, in accordance with embodiments of the current invention. Apart from differences described below, layup structure 8, and fluid delivery system 10 of FIGS. 7 to 11 are identical in notation, configuration, and functionality to that shown in FIGS. 1A, 2A, and 3 to 6, and elements indicated by the same reference numerals and/or letters are generally identical in configuration, operation, and functionality as described hereinabove.

FIGS. 7 to 11 are further intended to illustrate steps in a second method to form a composite material using composite fabrication system 104, as described hereinbelow. Referring specifically to FIG. 7, composite fabrication system 104, having layup support surface130, is directed to fabrication of composite material vessels, specifically bottles and/or elongated tanks, as detailed hereinbelow. The structure of composite layer 106 is similar to that of second composite layer 6a shown in FIGS. 2A, 2B, to 5 hereinabove—namely a matrix of a fiber reinforcement and a resin enclosed within a first and a second supporting membranes. In the current case, composite layer 106 has the first supporting membrane spread upon layup support surface 130 and a second supporting membrane spread upon the matrix. Composite layer 106 does not undergo a vibration step to reduce PCT-V (as described hereinabove in the case of first composite layer 6).

Layup support surface 130 is characterized by an elongated cylindrical shape having a first and a second end 131 and 132, respectively. Second end 131 is closed, having a substantial semispherical closure and first end 131 is open, having a substantially right-angle truncation. Layup support surface 130 is positioned substantially vertically with the first end opening onto layup support surface 20, centered substantially above inlet passage 22. A seal 136 is affixed at first end 131 and layup support surface 20. Layup support surface 130 has a plurality of holes 134 distributed therein to allow passage of a fluid, as described hereinbelow.

A first step in a second method to form a composite material using composite fabrication system 104 includes laying up composite layup 106, similar to the layup method described hereinabove with regard to second composite layup 6a, as follows:
a. spreading the first supporting membrane upon the layup support surface;
b. then spreading the fiber reinforcement over the first supporting membrane;
c. applying resin to the fiber reinforcement; and
d. spreading the second supporting membrane upon the matrix to form composite layup 106.

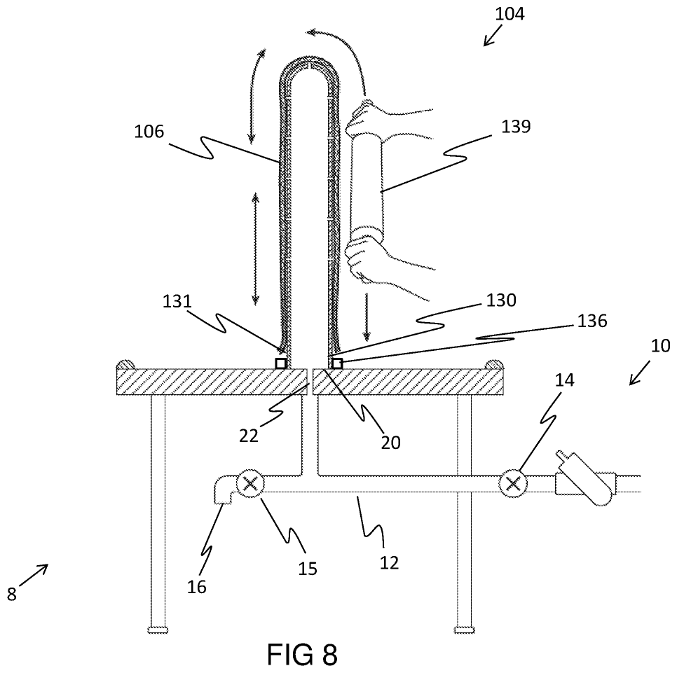

Referring to FIG. 8, the next step is to apply uniform pressure to composite layup 106 as shown schematically by a roller 139 and the directional arrows to displace excess resin 30 in the composite layup from between the two supporting membranes. Manual rolling—or any combination of rolling with electro-mechanical means with roller 139 yields good results in displacing excess resin and thereby effectively lowering the volume ratio of resin-to-fiber, R:F and as described hereinabove regarding FIG. 2A. It is noted that that the step of rolling also contributes to reducing PCT-V, described hereinabove.

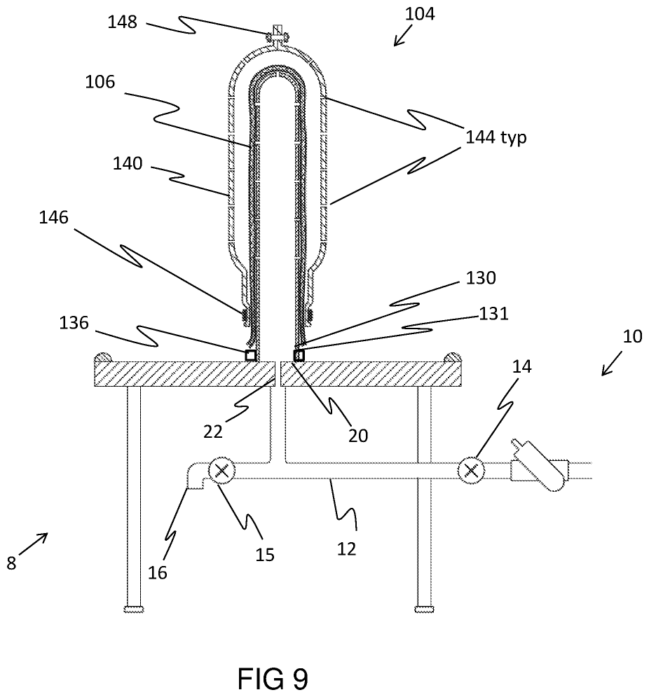

The next step in a second method, referring to FIG. 9, is to place a form 140 over composite layup 106, the form schematically shown in cross section. Form 140 has a volumetric internal shape corresponding to a shape of the final composite structure to be fabricated—in this case, an exemplary final structure such as, but are not limited to: a gas tank, a bottle, and a pressure-holding vessel. Form 140 has a plurality of vent openings 144, as further described hereinbelow. Form 140 may be formed of two mated halves, in which case connection 148 serves to tightly connect the mated halves—as shown in the figure. Removable seal 146, positioned at the end of form 140 towards first end 131, serves to seal the form together (in the case of two halves) and onto composite layup 106, which extends outside of the form, towards layup support surface 20, and against layup work surface 130. Stated differently, the removeable seal seals the composite layup between the form and the layup work surface 130. Except for contacting form 140 at removable seal 146, composite layup 106 is substantially not in contact with the form in the current step.

As a result, pressurized fluid, introduced through fluid inlet passage 22, is constrained and sealed within the tubular support-form structure, as described further hereinbelow.

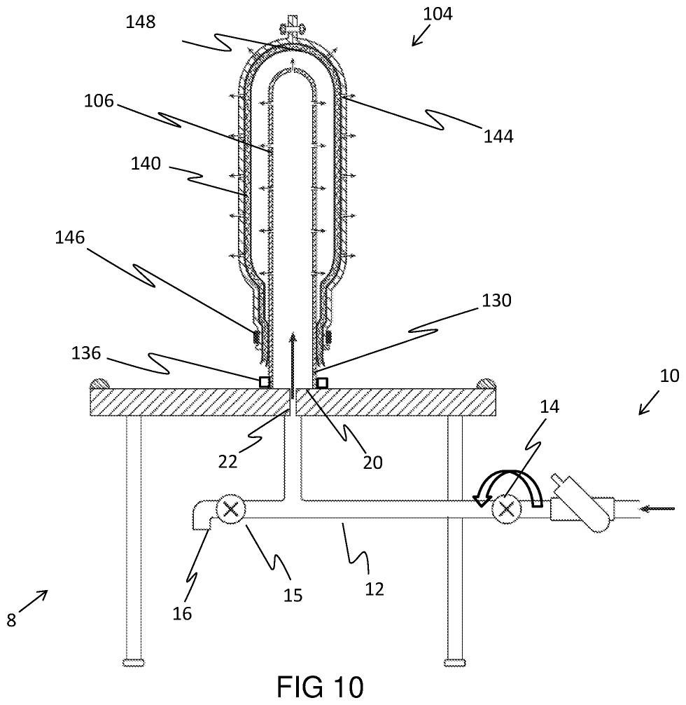

Referring to FIG. 10, the next step in the second method is to open main inlet fluid valve 14 to introduce a pressurized fluid (the fluid and its direction of flow indicated by arrows in the figure) into fluid inlet passage 22. Examples of the pressurized fluid and pressure values are similar to those described hereinabove. Typically, the pressurized fluid is heated above ambient temperature, the temperature and pressure of the fluid determined by resin curing qualities, as known in the art. Generally, higher fluid pressure and temperature yield faster curing times whereas lower fluid pressure and temperature yield slower curing times.

Introduction of the pressurized fluid into fluid inlet passage 22 inside of tubular form 140 (as shown by the arrow) and beneath composite layup 106 serves to expand the composite layup and to bias it intimately against form 140, as shown schematically in FIG. 10. The plurality of vent openings 144 serves to allow any ambient air to escape the form (as shown schematically by the smaller arrows) as the composite layup is effectively inflated and biased against form 140. In FIG. 4, main inlet fluid valve 14 remains in an open position as the pressurized fluid is maintained, as shown in the figure.

After a prescribed time (typically ranging a number of minutes, according to the curing characteristics of the resin) when the second composite layup has substantially completely cured, main inlet fluid valve 14 is closed, and then fluid venting valve 15 is opened to allow venting of the fluid to fluid vent outlet 16—all similarly to that shown as described hereinabove in FIG. 5.

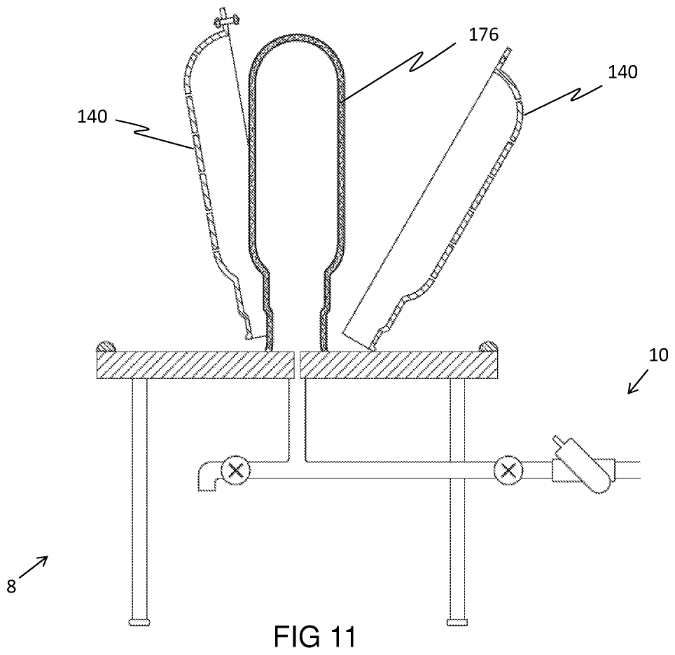

Once curing is completed, including any necessary cooling to ambient/near ambient conditions, removable seal 146 and form 140 (shown as two halves) are removed, and a cured composite structure 176 is enclosed in the supporting membranes as shown in FIG. 11. The supporting membranes are then removed from the cured composite structure and the structure is further shaped (i.e. machining, cutting, etc.) as known in the art. Because the smooth supporting membranes enclosed the matrix before and during curing, the cured composite structure exhibits a similar smooth surface finish.

Fabricating cured composite structure 176 using the second method described hereinabove yields a fully formed structure—with all of the concomitant advantages of strength, lower cost, and reliability, as opposed to similar prior art structures typically fabricated in two half structures that must be subsequently joined together.

The second method of to form a composite material using composite fabrication system 104 is summarized by the following steps:
1. Laying up composite layup 106 by:
   a. spreading the first supporting membrane upon layup support surface 130;
   b. spreading the fiber reinforcement over the first supporting membrane;
   c. applying resin to the fiber reinforcement; and
   d. spreading the second supporting membrane upon the matrix to form composite layup 106.
2. Applying uniform pressure to composite layup 106 using a roller to displace excess resin and lower R:F and effecting reduction of PCT-V.
3. Placing form 140 over the composite layup.
4. Sealing form 140 onto composite layup 106 and layup support surface 130 with removable seal 146.
5. Opening main inlet fluid valve 14 to introduce a pressurized fluid into fluid inlet passage 22 and to expand composite layup 104 and to bias it intimately against form 140.
6. Closing the main inlet fluid valve after composite layup 140 has substantially cured and then opening fluid venting valve 15 to vent the fluid.
7. Removing removable seal 146 and form 140 from cured composite structure 176 once curing is completed, following any necessary cooling to ambient/near ambient conditions.
8. Removing the supporting membranes from cured composite structure 176.

While embodiments of the current invention, described hereinabove in the first and the second methods, are directed to exemplary wet layup FRP processes using the composite fabrication system, the composite fabrication system may be used for other processes and materials, such as, but not limited to: prepreg, and carbon fibers; mutatis mutandis.

A salient point in embodiments of the current invention is that substantially all of composite structure fabrication is performed on the same, unified platform and work setup—namely the composite fabrication system described herein.

It will be appreciated that the above descriptions are intended only to serve as examples, and that many other embodiments are possible within the scope of the present invention as defined in the appended claims.

1. A composite fabrication system for fabricating a cured composite structure from a first composite layup comprising a matrix of resin and fiber reinforcement, the matrix configured upon a first supporting membrane, the matrix having a percentage of voids value (PCT-V) and a volumetric resin-to-fiber reinforcement ratio value (R:F), the system comprising:
a. a fluid control delivery system having a pressurized fluid at a pressure exceeding one atmosphere;
b. a layup structure having a layup support surface, the layup structure having a fluid inlet passage penetrating the layup support surface and connected to the fluid control delivery system;
c. the first composite layup positioned on the layup support surface with the first supporting membrane contacting the layup support surface and a vibrational element mechanically attached to the layup structure, with operation of the vibrational element serving to lower PCT-V;
d. a second composite layup formed of the first composite layup with a second supporting membrane spread upon the matrix, the matrix positioned between the first and second supporting membranes;
e. a roller configured to displace excess resin in the matrix and lower R;F;
f. a form having an internal, volumetric shape corresponding to a shape of the final composite structure, the form positioned over the second composite layup and the layup support surface, but substantially not contacting the second composite layup; and
g. a removable seal configured to seal the form over the second composite layup;
wherein the second composite layup is initially in contact with the form only at the removable seal, the pressurized fluid introduced by the fluid control delivery system serving to expand and bias the second composite layup intimately against the form.

2. The composite fabrication system according to claim 1, wherein the layup surface is substantially flat and horizontal and has at least one sealing element configured thereupon, located substantially at a periphery of the layup support surface.

3. The composite fabrication system according to claim 2, wherein the supporting membranes have an extended sheet shape and are formed from at least one material chosen from the list including: silicone rubber and vulcanized rubber.

4. The composite fabrication system according to claim 3, wherein the second composite layup extends over the entire layup support surface and over the at least one sealing element.

5. The composite fabrication system according to claim 4, wherein the removable seal is configured to seal the second composite layup against the at least one sealing element.

6. The composite fabrication system according to claim 5, wherein the pressurized fluid introduced by the fluid control delivery system is vented when the second composite layup is substantially completely cured.

7. The composite fabrication system according to claim 1, wherein the pressurized fluid is at least one chosen from the list including: a gas; water, and oil.

8. A method of fabricating a cured composite structure using the composite fabrication system according to claim 6, the method comprising the following steps:
a. laying up the first composite layup by:
i. spreading the first supporting membrane upon the layup support surface;
ii. spreading the fiber reinforcement over the first supporting membrane; and
iii. applying resin to the fiber reinforcement;
b. activating the vibrational element to outgas voids and to reduce PCT-V;
c. spreading the second supporting membrane upon the matrix to form the second composite layup;
d. applying uniform pressure to the second composite layup using a roller to displace excess resin and lower R:F;
e. placing a form over the second composite layup;
f. sealing the form onto the second composite layup with a removable seal, the second layup substantially not in contact with the form;
g. opening a main inlet fluid valve of the fluid control delivery system to introduce the pressurized fluid in the fluid inlet passage and beneath the second composite layup to expand the second composite layup and to bias it intimately against the form;
h. closing the main inlet fluid after the second composite layup has substantially cured, thereby yielding a cured composite structure, and then opening a fluid venting valve of the fluid control delivery system to vent the fluid;
i. removing the removable seal and the form from the cured composite structure once curing is completed, after any necessary cooling to ambient/near ambient conditions; and
j. removing the supporting membranes from the cured composite structure.

9. A composite fabrication system for fabricating a cured composite structure from a composite layup comprising a matrix of resin and fiber reinforcement, the matrix configured between a first and a second supporting membrane, the matrix having a percentage of voids value (PCT-V) and a volumetric resin-to-fiber reinforcement ratio value (R:F), the system comprising:
a. a fluid control delivery system having a pressurized fluid at a pressure exceeding one atmosphere;
b. a layup structure having a first layup support surface, the layup structure having a fluid inlet passage penetrating the first layup support surface and connected to the fluid control delivery system;
c. the composite layup positioned on a second layup support surface with the first supporting membrane contacting the layup support;
d. a roller configured to displace excess resin in the matrix and lower R;F and PCT-V;
e. a form having an internal, volumetric shape corresponding to a shape of the final composite structure, the form positioned over the composite layup and the layup support surface, but substantially not contacting the second composite layup; and
f. a removable seal configured to seal the form over the composite layup and against the second layup support surface;
wherein the composite layup is initially in contact with the form only at the removable seal, the pressurized fluid introduced by the fluid control delivery system serving to expand and bias the composite layup intimately against the form.

10. The composite fabrication system according to claim 9, wherein the second layup support surface has an elongated cylindrical shape having a first and a second end, respectively, the second end closed, having a substantial semispherical closure, and the first end open, having a substantially right-angle truncation.

11. The composite fabrication system according to claim 9, wherein the second layup support surface is positioned substantially vertically, with the first end opening onto the first layup support surface, centered substantially above inlet passage, and sealed at the first end onto the first layup support surface.

12. The composite fabrication system according to claim 11, wherein the supporting membranes have an extended sheet shape and are formed from at least one material chosen from the list including: silicone rubber and vulcanized rubber.

13. The composite fabrication system according to claim 12, wherein the composite layup extends over the entire second layup support surface, towards the first layup support surface.

14. The composite fabrication system according to claim 13, wherein the removable seal is positioned at an end of the form, towards the first end, the removeable seal configured to seal the composite layup between the form and the second layup surface.

15. The composite fabrication system according to claim 14, wherein the pressurized fluid introduced by the fluid control delivery system is vented when the composite layup is substantially completely cured.

16. The composite fabrication system according to claim 9, wherein the pressurized fluid is at least one chosen from the list including: a gas; water, and oil.

17. A method of fabricating a cured composite structure using the composite fabrication system according to claim 15, the method comprising the following steps:
a. laying up the composite layup by:
i. spreading the first supporting membrane upon the layup support surface;
ii. spreading the fiber reinforcement over the first supporting membrane; and
iii. applying resin to the fiber reinforcement;
iv. spreading the second supporting membrane upon the matrix;
b. applying uniform pressure to the composite layup using a roller to displace excess resin and lower R:F and to reduce PCT-V;
c. placing a form over the second composite layup;
d. sealing the form onto the second composite layup with a removable seal, the composite layup substantially not in contact with the form;
e. opening a main inlet fluid valve of the fluid control delivery system to introduce the pressurized fluid in the fluid inlet passage and inside the composite layup to expand the composite layup and to bias it intimately against the form;
f. closing the main inlet fluid after the composite layup has substantially cured, thereby yielding a cured composite structure, and then opening a fluid venting valve of the fluid control delivery system to vent the fluid;
g. removing the removable seal and the form from the cured composite structure once curing is completed, after any necessary cooling to ambient/near ambient conditions; and
h. removing the supporting membranes from the cured composite structure.
